(19) United States
(12) Patent Application Publication
(10) Pub. No.: US 2005/0081426 A1
(43) Pub. Date: Apr. 21, 2005

(54) Snail and slug fences

(76) Inventor: Chih-Yu Hsia, Arcadia, CA (US)

Correspondence Address: Chih-Yu Hsia, 301 Warren Way, Arcadia, CA, 91007, US

(21) Appl. No.: 10/688,451

(22) Filed: Oct. 18, 2003

(51) Int. Cl. A01M 1/00

(52) U.S. Cl. 43/124

(57) ABSTRACT

A snail and slug fence comprising in combination: a base which encircles a ground area when the snail and slug fence is in an up right position; a rim plate which has a surface with substantially needle-like protruding objects; one end of the base connecting with the rim plate; the substantially needle-like protruding objects pointing downwards approximately vertically when the snail and slug fence is in an up right position; a component of a snail and slug fence comprising in combination: a base which, at one edge, has a male connection mean which can engage with a female connection mean of other component of snail and slug fence; the base, at the opposite edge which has the male connection mean, having a female connection mean which can engage with a male connection mean of other component of snail and slug fence; a rim plate which has a surface with substantially needle-like protruding objects; one edge of the base connecting with the rim plate; the substantially needle-like protruding objects pointing downwards approximately vertically when the component of the snail and slug fence is an up right position; and, a component of a snail and slug fence comprising a strip that has a surface partially filled with substantially needle-like protruding objects along the strip.

### BACKGROUND OF THE INVENTION

1. Field of the Invention

This invention relates to barriers or fences that a snail or a slug can not climb over. Particularly the barriers or fences have many downward pointing needle-liked objects which prevent a snail or a slug to crawl through and which needle points do not provide enough surface areas for a snail or a slug to hang onto. A snail or a slug thus can not pass though the downward pointing needle-liked objects. Therefore, the invented snail and slug fences can prevent snails or slugs to climb over.

2. Descriptions of the Prior Arts

No prior art related to snail and slug fences was found.

### SUMMARY OF THE INVENTION

Snails and slugs often damage or destroy young plants. Very often they destroy the most favorite plants in a garden overnight. The conventional methods to control or reduce the threats of snails and slugs include chemical controls and less toxic controls such as handpicking at night, using copper strip barriers, using covers, using traps, and encouraging natural predators, etc. However, every one of these methods has drawbacks. For examples, the chemical controls may damage and threat environment, pets, and other helpful creatures and insects. The handpicking at night and the using traps are time consuming. The uses of copper strip barriers do not guarantee keeping the snails and slugs away all the time. The using covers often require the replacements of the covers with bigger ones. Therefore, an improved mean or device that reduces the threats of snails and slugs is sought.

Snails and slugs are closely related. They both have soft oblong bodies and produce quantities of slime to help them move around. One of the best means to prevent them from moving around is to create a barrier which they can not penetrate through nor climb over or under. A fence and its alike therefore is invented.

There are three main variations of the invented snail and slug fences: the individual fences, the components that jointly make the fences, and the components that are mounted onto something else to make the fences. An individual fence consists of a base that can encircle a ground area, and a rim plate that has a surface with many downward pointing needles when the base is pushed onto ground for uses. The components that jointly make a fence consists of a base which has a male connection mean and a female connection mean, and a rim plate which has a surface with many downward pointing needles when the components of the snail and slug fence is in use. The components that are mounted onto something else to make the fences comprise a strip that has a surface partially filled with needles along the strip. The individual fences can be used independently as snail and slug fences. The invented components have to either jointly to make the fences or be mounted onto something else to make the fences. For all of the variations, the downward pointing needles prevent a snail or a slug to crawl through. The needlepoint of the downward point needles does not provide enough surface areas for an upside down snail or slug to hang onto. Therefore, the snail and slug fences are invented.

These and other objects and advantages of the invention, as well as the details of illustrative embodiments, will be more fully understood from the following specification and drawings, in which:

### DRAWING DESCRIPTION

FIG. 1 is an isometric view of one variation of the first variation of the invented device.

FIG. 2 is a cut-away isometric view of the device shown in FIG. 1.

FIG. 3 is a sectional view of the device shown in FIG. 1.

FIG. 4 is a sectional view of a variation of the device shown in FIG. 1.

FIG. 5 is a sectional view that illustrates the uses of the devices shown in FIG. 4.

FIG. 6 is an isometric view of a variation of the first variation of the invented device.

FIG. 7 is an isometric view of a component of the second variation of the invented device. A cut-away is made to show additional details.

FIG. 8 is an isometric view of another component of the second variation of the invented device.

FIG. 9 illustrates the use of two components shown in FIG. 7 to form one of the second variation of the invented device.

FIG. 10 illustrates the use of two components shown in FIGS. 7 and 8 to form a portion of the second variation of the invented device. A completed snail and slug fence can be built with many of the devices shown in FIGS. 7 and 8.

FIG. 11 is an isometric view of a component of another variation of the second variation of the invented device.

FIG. 12 is an isometric view of a variation of a component of the second variation of the invented device.

FIG. 13 is an isometric view of the variation of the invented device shown in FIG. 11. An element of the component shown in FIG. 111 is broken-off and the remaining of that element is bent approximately 90 degrees for the connections shown in FIG. 14.

FIG. 14 illustrates the use of three components shown in FIG. 11 to form a portion of the second variation of the invented device. A completed snail and slug fence can be built with many of the devices shown in FIG. 11 or 12.

FIG. 15 is a cross-sectional view of a component of the third variation of the invented device.

FIG. 16 is a cross-sectional view of a fence loop of the third variation of the invented device shown in FIG. 15.

### GENERAL DESCRIPTION

Three main variations of the invented device are introduced herein in this specification.

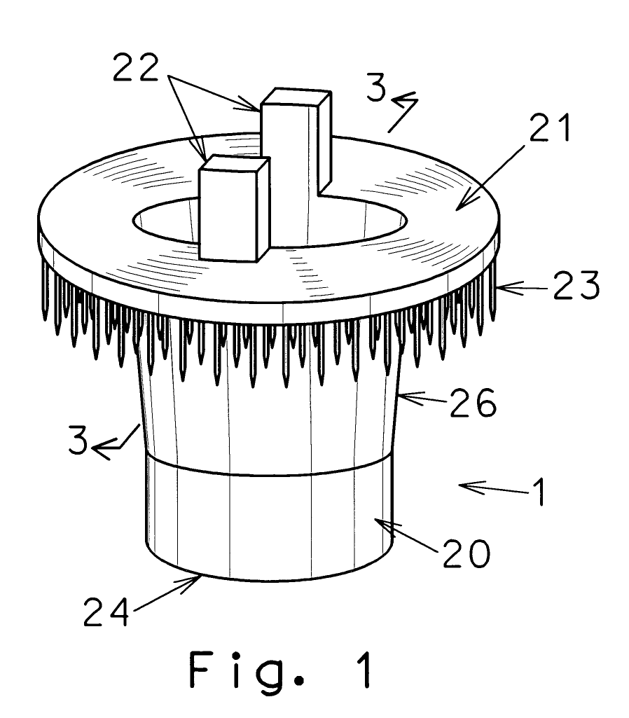

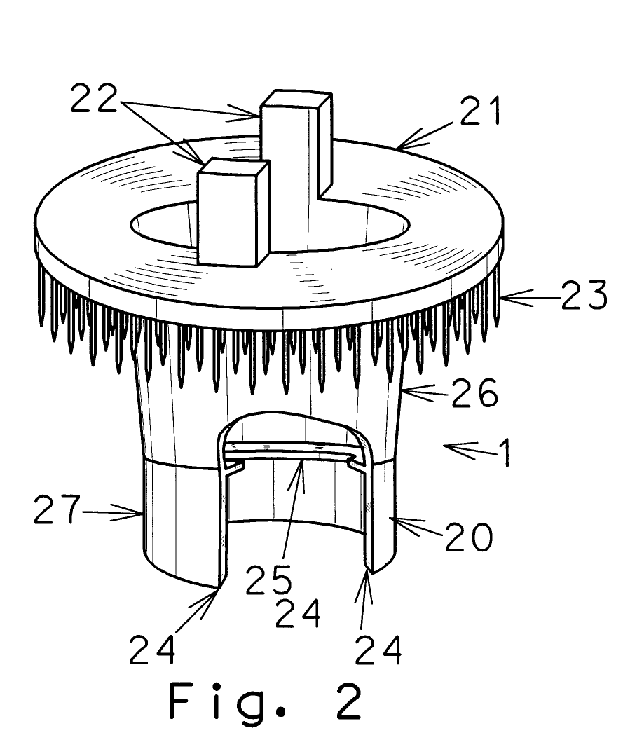

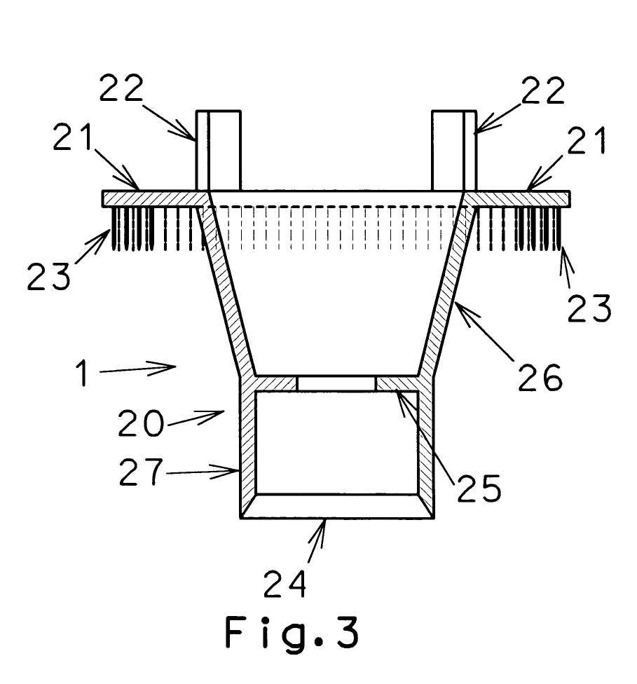

Referring to FIGS. 1, 2 and 3, the first main variation, the individual fences, of the invented snail and slug fences 1 consists of a base 20, a rim plate 21, and one or many optional handles 22. The rim plate is a small plate which one surface has many fence needles 23 (some of the fence needles are represented by single lines in order not to cloud the figures). The fence needles are rows of substantially needle-liked objects protruding approximately perpendicular to the surface of the rim plate. The fence needles are spaced apart and may optionally have different lengths. The handle is an object protruding from the rim plate's surfaces that do not have the fence needle. The base is a short tube-liked object which one end connects to the rim plate with the surface that has the fence needles. The other end of the base has a sharp edge 24. The base may optionally have different cross-sectional areas longitudinally. The base may optionally have a plate 25 protruding from it surface. For an example, the base in FIGS. 1, 2 and 3 consists of a conical tube section 26 above and a circular tube section 27 below and the plate 25 at the interior surface that the conical tube section joins with the circular tube section.

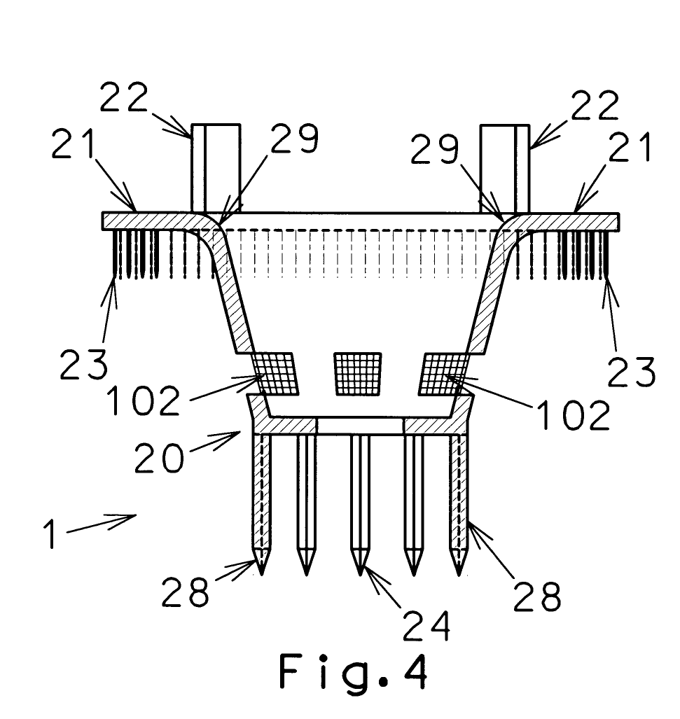

Referring to FIG. 4, a variation of the first main variation of the invented device 1 which base 20 has screens 102 and which sharp edge 24 is represented by substantially needle-like protruding objects 28. A rounded surface 29 joins the base 20 and the rim plate 21. The handles 22 and the fence needles 23 are the same as those described in the previous paragraphs.

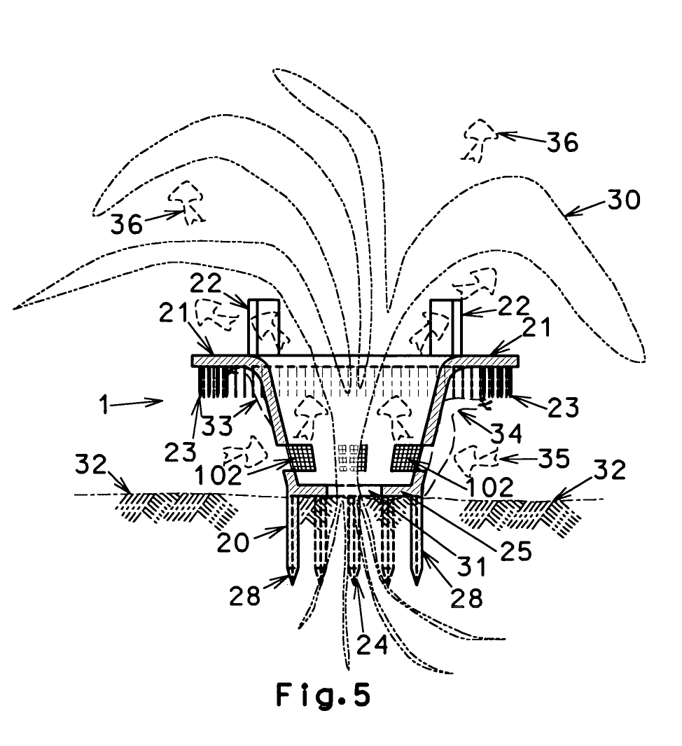

Referring to FIG. 5, in using an invented snail and slug fence 1 the user lets the planted vegetation 30, which is to be protected from snail and slug, through the hollow 31 of the base 20. Then, the user pushes the device partially into the soil 32. The user may use the handles 22 to push down the device if the handles exist. The sharp edge 24 and/or the substantially needle-like protruding objects 28 facilitate the pushing down of the device into soil. The plate 25 not only provides a mark that the device has to be pushed down to but also prevents the device from being pushed down too deep into the soil. When the bottom of the plate 25 touches the soil, the device is in an up right position and the fence needles 23 (some of the fence needles are represented by single lines in order not to cloud the figures) are pointing downwards approximately vertically. The substantially needle-liked objects of the fence needles are so spaced apart that the fence needles provide a barrier that a snail or a slug 33 can not squeeze through. The only way a snail or a slug can passes through the fence needles is through the tips of the fence needles. However, there are rows of fence needles and the tips of the fence needles do not provide enough areas for an upside-down snail or slug to hold on to. The snail or slug 34 can not overreach to the sides of the other side of the fence needles nor hold onto the tips of the fence needles. The snails or slugs can not pass the fence needles without falling off of the fence needles. Therefore, the invented device can be a fence that prevents snails or slugs to climb over. The screens 102 are fine enough to stop a snail or a slug to pass through. The screens provide passes for breeze 35 for air circulation 36. The conical tube section enables the invented devices to be stacked up for transportation.

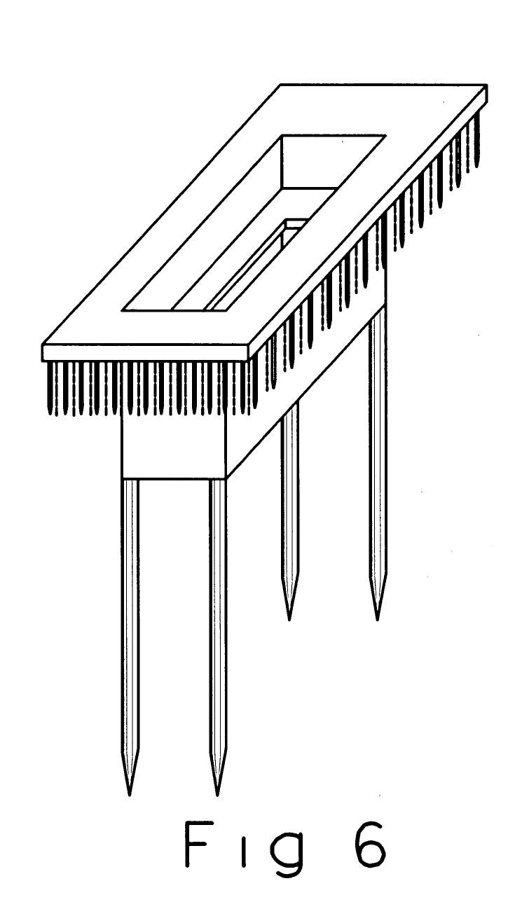

The footprint of a base can be non-circular. FIG. 6 shows an example of the device that has non-circular footprint base.

The invented snail and slug fences can be constructed in the field with components. This allows the devices to cover a large area in which vegetation is to be protected from snails and slugs.

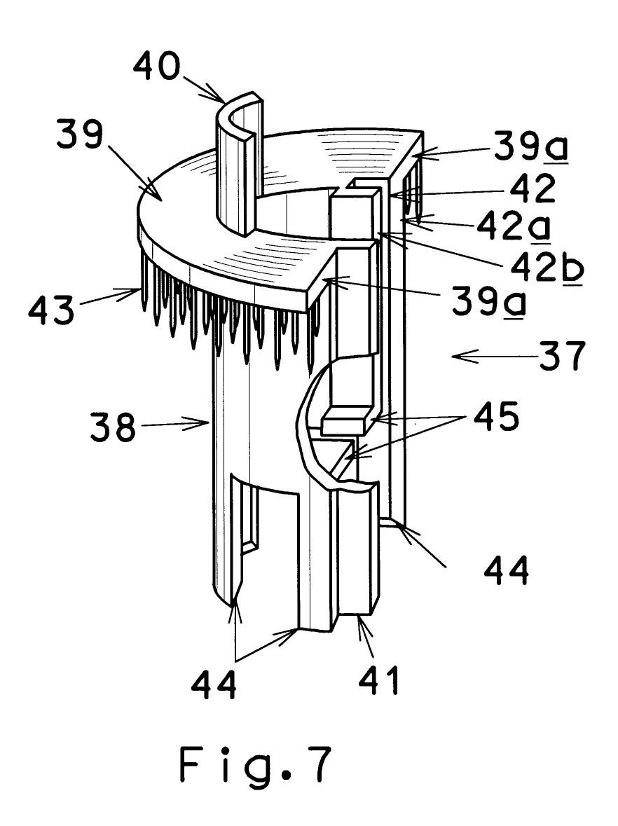

Referring to FIG. 7, the component for snail and slug fences 37 consists of a base 38, a rim plate 39, and one or many optional handles 40. The rim plate and the handles are the same as those described for FIGS. 1, 2 and 3. The base is a plate that, at one edge, has a male connection mean 41 that can be simply a protruding plate. At the opposite edge that has the male connection mean the base has a female connection mean 42 that can be simply a slot between two parallel small plates 42a and 42b. The male connection mean can engage with a female connection mean of other component of a snail and slug fence. The female connection mean can engage with a male connection mean of other component of a snail and slug fence. The dimensions of the male connection means and the female connection means are so selected that a male connection mean of one invented component can be tightly fitted into a female connection mean of another invented component. The dimensions also will allow the edges 39a of the rim plate 39 to butt against the edges of the rim plate of another invented component. The third edge of the base connects to the rim plate with the surface that has the fence needles 43. The fourth edge of the base has a sharp edge or sharp-edged protruding objects 44. The base may optionally have a plate 45 protruding from it surface.

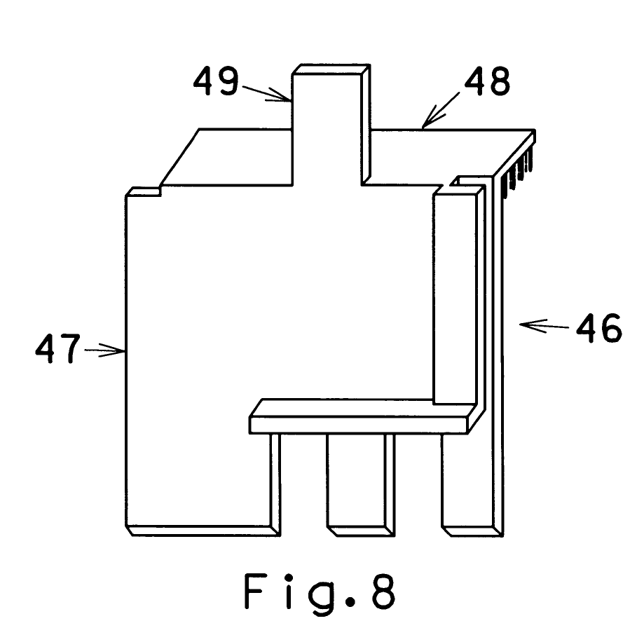

Referring to FIG. 8, one variation of the components for snail and slug fences 46 consists of a base 47, a rim plate 48, and one or more optional handles 49. The base, the rim plate and the handles are similar to those described for FIG. 7.

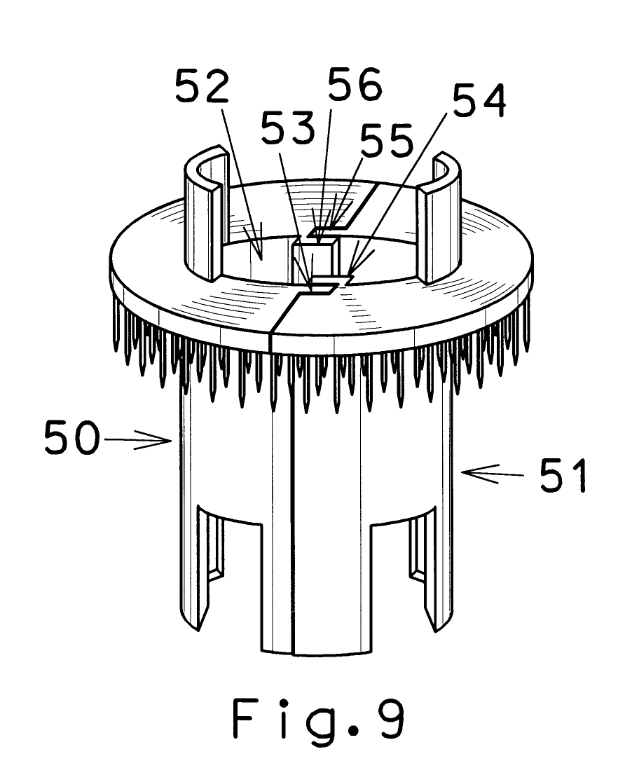

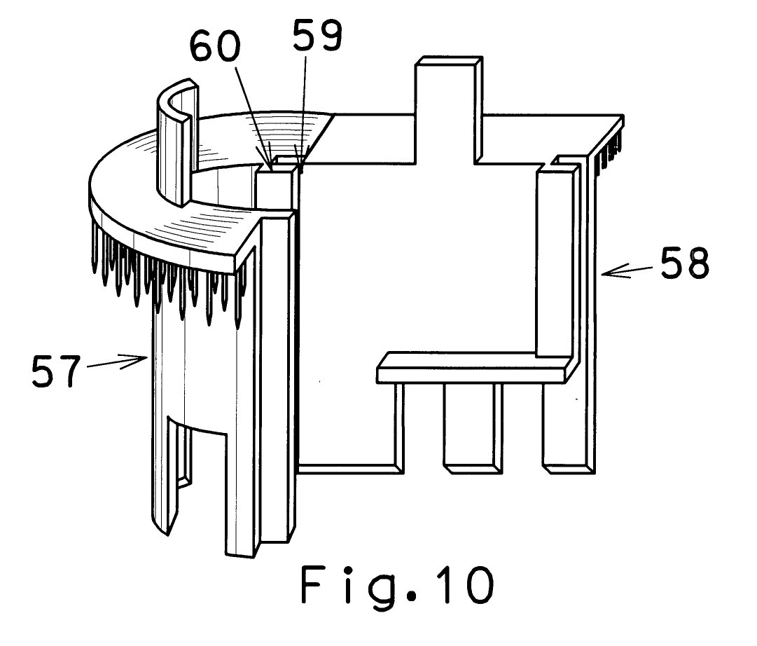

In using the invented devices shown in FIGS. 7 and 8, the user can join the components together by connecting the male connection mean of one component of the invented device with the female connection mean of another component of the invented device, or vice versus. The joining of the components can be made continuously until a continuous loop of the joined invented components is made. Referring to FIG. 9 for joining the components shown in FIG. 7, one component 50 joins with another component 51 to form the fence loop 52. In the joining, the male connection mean 53 of the component 50 joins with the female connection mean 54 of the component 51 while the male connection mean 55 of the component 51 joins with the female connection mean 56 of the component 50. Referring to FIG. 10 for joining the components shown in FIGS. 7 and 8, one component 57 joins with another component 58 by joining the male connection mean 59 of the component 58 with the female connection mean 60 of the component 57. Additional components are needed to form a continuous fence loop.

The connections of invented components to make a fence loop can be done with all of the invented components are above ground. Or, the joining can be made with a preceding invented component is already in the ground then followed by a succeeding invented component. The fence loop made from the invented components of a snail and slug fence will prevent slugs or snails to climb over thus the vegetation inside the looped area can be protected.

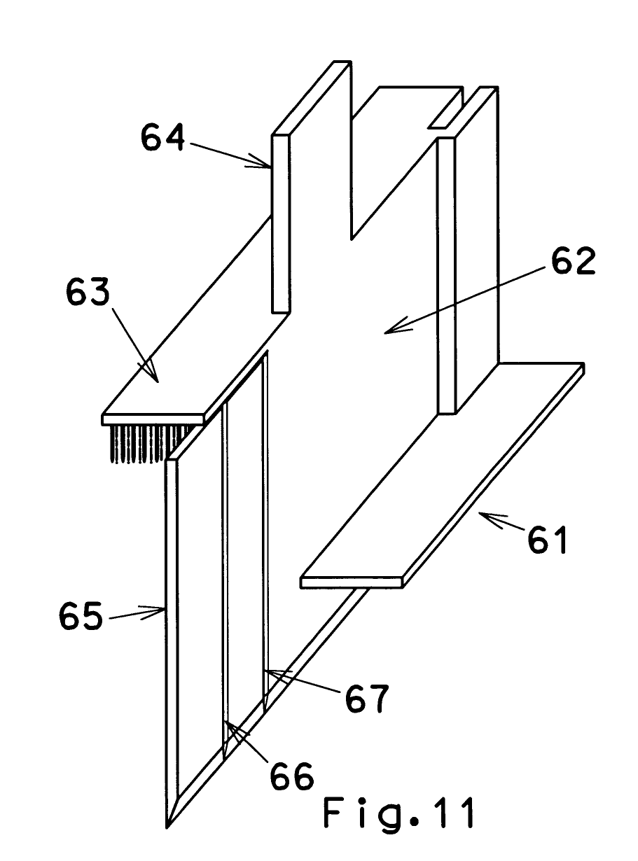

Referring to FIG. 11, one variation of the components for snail and slug fences 61 consists of a base 62, a rim plate 63, and one or more optional handles 64. The base, the rim plate and the handles are similar to those described for FIG. 7 except that the male connection mean 65 of the base 62 has two optional grooves 66 and 67. The groove 66 allows the male connection mean to be savored along the groove so that the length of the male connection mean is short enough to allow the rim plate 63 to butt against the rim plate of another invented component. The groove 67 allows the male connection mean to be bent easily along the groove.

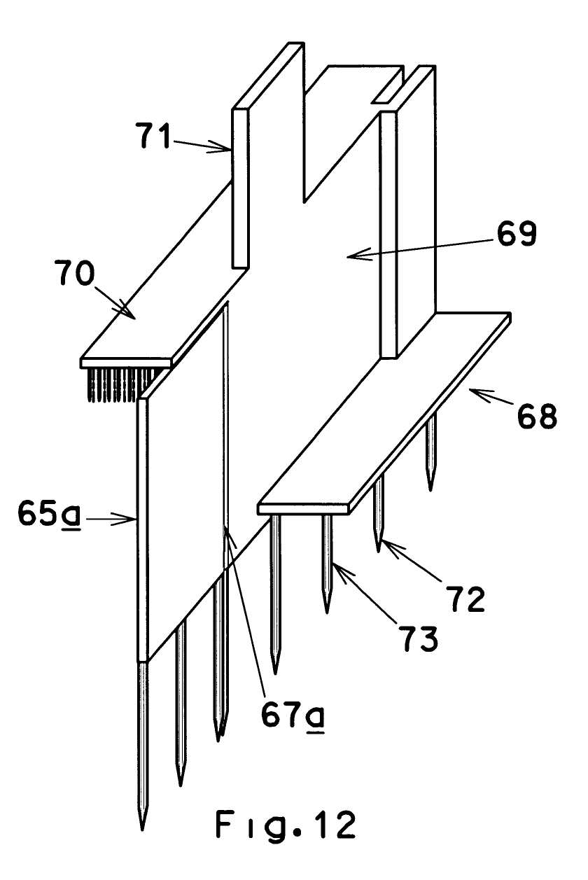

Referring to FIG. 12, another variation of the components for snail and slug fences 68 consists of a base 69, a rim plate 70, and one or more optional handles 71. The base, the rim plate and the handles are similar to those described for FIG. 1I except that the sharp edge 72 of the base 69 are pins 73 and the male connection mean 65a has only one groove 67a.

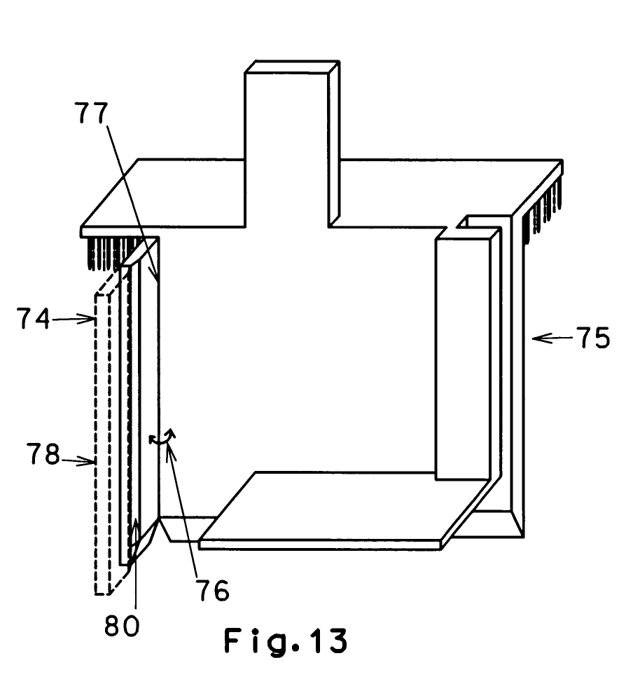

A component that provides a mean for making a sharp-angled bend for a snail and slug fence can be made from the male connection mean of the components shown in FIG. 11 or 12. Referring to FIG. 13, male connection mean 74 of the invented component 75 that is the same invented component 61 shown in FIG. 11 can be bent to a sharp angle 76 (approximately 90 degrees) along the groove 77 (shown as a line after the bending). The front portion 78 of the male connection mean 74 can be savored along the groove 80. The remaining portions of the component provide the mean for making a sharp-angled bend for making a snail and slug fence.

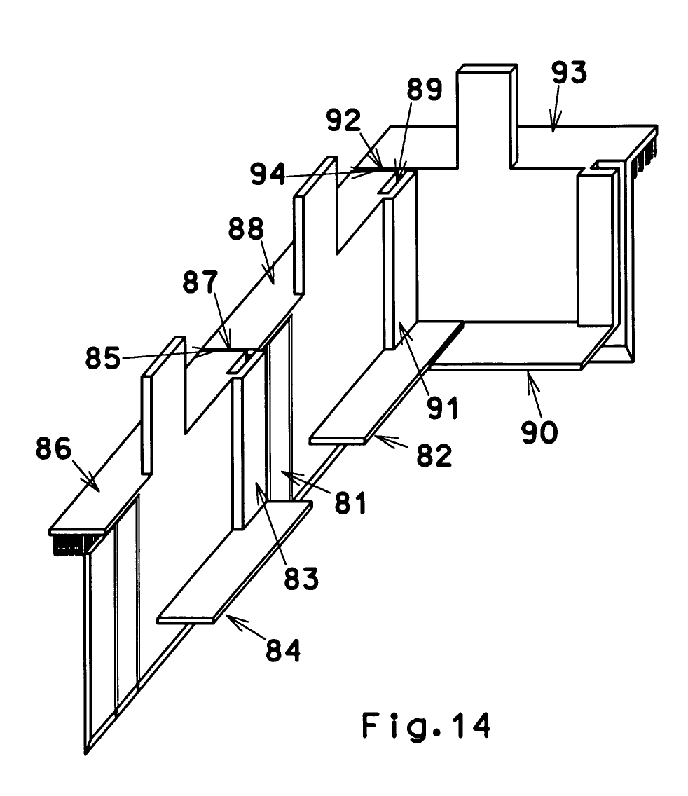

Referring to FIG. 14, to form a snail and slug fence loop with the invented components, the user connects the male connection mean 81 of a component 82 with the female connection mean 83 of the component 84. In the connection the edge 85 of the rim plate 86 of the component 84 butts against the edge 87 of the rim plate 88 of the component 82. To make a sharp-angled bend for the fence loop, the user bends the male connection mean to makes a component the same as this shown in FIG. 13. Then, the user connects the male connection mean 89 of the component 90 with the female connection mean 91 of the component 82. In the connection the edge 92 of the rim plate 93 of the component 90 butts against the edge 94 of the rim plate 88 of the component 82. The connection processes are continued until a snail and slug fence loop is made. Once again, all of the connections can be made with all of the invented components are above ground. Or, the joining can be made with the preceding invented component is already in the ground then followed by a succeeding invented component. The fence loop of a snail and slug fence can prevent slugs or snails to climb over thus the vegetation inside the looped area can be protected.

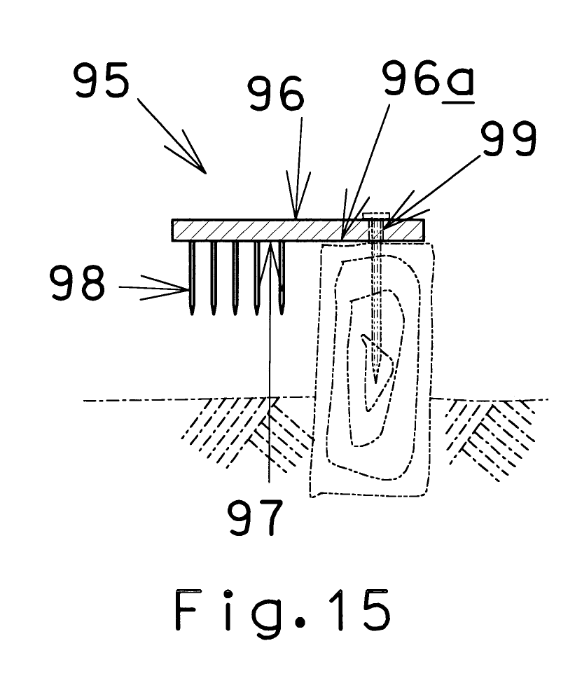

Referring to FIG. 15, the component of the invented snail and slug fence 95 consists of a strip 96 which one of its face 97 partially filled with substantially needle-like protruding objects 98 along the length of the entire strip. Many optional nail holes 99 are along the side 96a of the strip that does not have the substantially needle-like protruding objects 98.

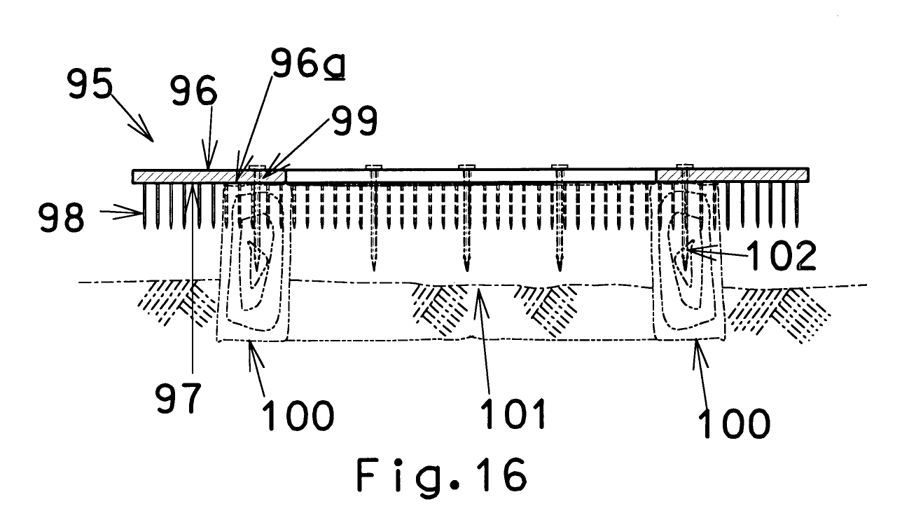

Referring to FIG. 16, in using the invented component shown in FIG. 15, the user firstly plants wood blocks 100 to enclosed an area 101 in which vegetation to be protected. Then, the user places the invented component 95 along a wood block with the substantially needle-like protruding objects 98 on the exterior sides of the enclosed area 101. The user then staples or nails down onto the wood blocks 100 the side 96a of the strip that does not have the substantially needle-like protruding objects 98. The user places the invented components on the wood block around the enclosed area 101. Then a snail and slug fence is made. The substantially needle-like protruding objects 98 will prevent snails or slugs to penetrate or climb through the snail and slug fence.

The foregoing is considered as illustrative only of the principles of the invention. Furthermore, since numerous modifications and changes will readily occur to those skilled in the art, it is not desired to limit the invention to the exact construction and operation shown and described, and accordingly all suitable modifications and equivalents, may be resorted to, falling within the scope of the invention as claimed.

1. A snail and slug fence comprising in combination:
a) a base which encircles a ground area when said snail and slug fence is in use;
b) a rim plate which has a surface with substantially needle-like protruding objects;
c) one end of said base connecting with said rim plate;
d) said substantially needle-like protruding objects pointing downwards approximately vertically when said snail and slug fence is in use.

2. A snail and slug fence of claim 1 wherein said substantially needle-like protruding objects occupy a portion of said surface of said rim plate.

3. A snail and slug fence of claim 1 wherein said substantially needle-like protruding objects have different lengths.

4. A snail and slug fence of claim 2 wherein said substantially needle-like protruding objects have different lengths.

5. A snail and slug fence of claim 1 wherein said rim plate has a handle protruding from a surface which does not have said substantially needle-like protruding objects.

6. A snail and slug fence of claim 1 wherein said rim plate has a handle in plural form protruding from a surface which does not have said substantially needle-like protruding objects.

7. A snail and slug fence of claim 1 wherein said base has a plate protruding from a surface.

8. A snail and slug fence of claim 1 wherein said base has a plate in plural form protruding from a surface.

9. A snail and slug fence of claim 1 wherein the two end openings of said base have different cross sectional areas.

10. A snail and slug fence of claim 1 wherein the end of said base that does not have said rim plate has a sharp edge.

11. A snail and slug fence of claim 1 wherein the end of said base that does not have said rim plate consists of sharp-edged spaced-apart objects.

12. A snail and slug fence of claim 1 wherein said base has a screen.

13. A snail and slug fence of claim 1 wherein said base has multiple screens.

14. A component of a snail and slug fence comprising in combination:
a) a base which, at one edge, has a male connection mean which can engage with a female connection mean of other said component of snail and slug fence;
b) said base, at the opposite edge which has said male connection mean, having a female connection mean which can engage with a male connection mean of other said component of snail and slug fence;
c) a rim plate which has a surface with substantially needle-like protruding objects;
d) one edge of said base connecting with said rim plate;
e) said substantially needle-like protruding objects pointing downwards approximately vertically when said component of snail and slug fence is in use.

15. A component of a snail and slug fence of claim 14 wherein said substantially needle-like protruding objects occupy a portion of said surface of said rim plate.

16. A component of a snail and slug fence of claim 15 wherein said substantially needle-like protruding objects have different lengths.

17. A component of a snail and slug fence of claim 14 wherein said substantially needle-like protruding objects have different lengths.

18. A component of a snail and slug fence of claim 14 wherein said rim plate has a handle protruding from a surface which does not have said substantially needle-like protruding objects.

19. A component of a snail and slug fence of claim 14 wherein said rim plate has a handle in plural form protruding from a surface which does not have said substantially needle-like protruding objects.

20. A component of a snail and slug fence of claim 14 wherein said base has a plate protruding from a surface.

21. A component of a snail and slug fence of claim 14 wherein said base has a plate in plural form protruding from a surface.

22. A component of snail and slug fence of claim 14 wherein said male connection mean consists of a plate protruding from said one edge and said female connection mean consists of two substantially parallel plates protruding from said opposite edge.

23. A component of snail and slug fence of claim 22 wherein said plate of said male connection mean has a groove along which allows the bending of said plate.

24. A component of snail and slug fence of claim 22 wherein said plate of said male connection mean has two grooves along which allow the bending or savoring of said plate.

25. A component of a snail and slug fence of claim 14 wherein the end of said base that does not have said rim plate has a sharp edge.

26. A component of a snail and slug fence of claim 14 wherein the end of said base that does not have said rim plate consists of sharp-edged spaced-apart objects.

27. A component of a snail and slug fence of claim 14 wherein said base has a screen.

28. A component of a snail and slug fence of claim 14 wherein said base has multiple screens.

29. A component of a snail and slug fence comprising a strip that has a surface partially filled with substantially needle-like protruding objects along said strip.

30. A component of a snail and slug fence of claim 29 wherein said strip has a hole in plural form.
